(19) United States
(12) Patent Application Publication
(10) Pub. No.: US 2003/0139309 A1
(43) Pub. Date: Jul. 24, 2003

(54) Fabric care compositions

(75) Inventors: John Brockett, Edgewater, NJ (US); Deborah Marie Coccaro, Edgewater, NJ (US); Michel Gilbert Delroisse, Vlaardingen (NL); Karen Jane Ellson, Bebington (GB); Nancy Ann Falk, Edgewater, NJ (US); Dennis Stephen Murphy, Edgewater, NJ (US); Michael Orchowski, Edgewater, NJ (US); Stephane Ugazio, Sophia Antipolis (FR); Antje Minke Wierenga, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/336,538

(22) Filed: Jan. 3, 2003

(30) Foreign Application Priority Data
Jan. 4, 2002 (GB) 0200152.7

(51) Int. Cl. C11D 1/00

(52) U.S. Cl. 510/267; 510/507

(57) ABSTRACT

A fabric care composition comprises a solid carrier and an anti-wrinkle agent. The composition may be used to provide fabrics with softness and/or anti-wrinkle and/or other fabric benefits in laundering processes.

### TECHNICAL FIELD

This invention relates to fabric care compositions, to the use of the compositions in fabric treatment and to a method of treating fabric with the compositions.

### BACKGROUND AND PRIOR ART

The sensory feel of a fabric following conventional laundering processes is an important property. In particular, the “softness” of a fabric is a highly desirable quality in the laundered fabric. The term “softness” generally refers, for example, to the feeling of smoothness to the touch and flexibility of the fabric. In addition, the term “softness” refers to the general feeling of comfort registered by the human skin on contact with the fabric. The term “softness” is particularly considered to mean a lack of sensory negatives such as fabric stiffness and abrasiveness.

In addition to conferring softness benefits, it is also advantageous to reduce the extent of wrinkling, or creasing, of a fabric following laundering processes. The use of anti-wrinkle agents helps to reduce the need for ironing and thus saves on both the time and energy required for the laundering process. The terms “crease” and “wrinkle” and related terms, such as “anti-crease” and “anti-wrinkle”, refer to non-permanent deformations in the fabric which can be removed by flattening at elevated temperature and moisture (e.g. by ironing) and are used synonymously herein.

A considerable number of additives have been developed for incorporation in or addition to, for example, the main wash cycles or tumble drying sequence of fabric laundering processes or industrial textile treatment processes in order to impart “softness” benefits. Treatments have also been proposed for imparting anti-wrinkle benefits to fabric.

Thus, it is well known in the art that some clay materials may be used to impart softening and antistatic properties when deposited on fabrics. Such clay deposition is generally achieved by contacting fabrics with high concentrations of an aqueous suspension of the clay under closely controlled conditions during commercial manufacturing and treatment processes. U.S. Pat. No. 4,062,647 discloses a detergent composition comprising specified amounts of water soluble non-soap synthetic detergent, an inorganic or organic detergent builder salt and a smectite clay with specified cation exchange characteristics. The clay is not pre-treated with any organic compound prior to inclusion in the formulation. According to U.S. Pat. No. 4,062,647, these compositions provide fabric softening and/or anti-static benefits.

In order to provide the improved softening benefits claimed therein, U.S. Pat. No. 5,443,750 discloses detergent compositions comprising a specified cellulase and a softening clay such as, for example, a heat treated kaolin or various multi-layer smectites. The softening clays disclosed in this document have not been pre-treated with organic compounds. According to U.S. Pat. No. 5,433,750, the combination of specified cellulase and clay leads to a synergistic improvement in softness benefits. Preferably, the compositions also comprise a flocculating agent. Liquid detergents further comprise an antisettling agent such as, for example, an organophilic clay (e.g. Bentone®).

U.S. Pat. No. 3,918,983 describes a textile treatment comprising particular sulfated castor oil substitutes and the use of these sulfated derivatives as textile softeners when applied as finishes. The sulfated castor oil substitutes disclosed comprise specified amounts of at least one sulfated aliphatic alcohol, having from about 4 to about 30 carbon atoms, in conjunction with specified amounts of at least one sulfated unsaturated oil, other than castor oil.

WO 00/24857 discloses a laundry detergent product comprising a wrinkle reducing agent selected from one or more of a specified range of compounds, including sulfated and sulfonated vegetable oils. There is no disclosure of pre-mixing the wrinkle reduction agent and the carrier.

GB-A-2,357,523 discloses the use of clays for imparting wrinkle reduction and ease of ironing benefits.

It remains desirable to have improved systems for treating fabric that provide fabric softness and/or anti-wrinkle benefits.

The present invention aims to provide a fabric care composition affording softness benefits to fabric treated with the composition. The present invention also aims to provide a fabric care composition affording anti-wrinkle benefits to fabric treated with the composition. The compositions of the invention may provide one or more other advantages in fabric treated with the compositions, the advantages including one or more of: better shape, body, improved texture, improved colour (including surface colour definition), better antistatic properties, reduced friction, better comfort in wear, increased water absorption and better durability (i.e., resistance to wear). In a particularly preferred embodiment, the compositions of the invention are used for reducing the extent of creasing of fabric, such as before and/or during and/or after laundering.

### STATEMENT OF INVENTION

According to the present invention, there is provided a fabric treatment composition comprising:

(i) a solid carrier; and

(ii) an anti-wrinkle agent

The compositions may also contain water. The anti-wrinkle agent is preferably a liquid.

In a further aspect of the invention, there is provided the use of the compositions of the invention to provide softness benefits for fabric.

In yet a further aspect of the invention, there is provided the use of the compositions of the invention to provide anti-wrinkle benefits for fabric.

In yet another aspect of the invention, there is provided a method of treating a fabric comprising applying to the fabric the composition of the invention.

In yet another aspect still of the invention, there is provided the use of functionalised oil as a dispersing agent for use in fabric care compositions including a solid carrier and water.

In a yet further aspect of the invention, there is provided the use of a solid carrier as a deposition agent in fabric treatment compositions comprising an anti-wrinkle agent.

The invention also provides a process of preparing a free-flowable antiwrinkle agent suitable for inclusion in a powder or tablet detergent product, comprising the steps of:

a) combining a functionalised oil with a solid carrier selected from clays, zeolites, sugar or derivatives thereof, solid salts, starch or derivatives thereof, and mixtures thereof to form an admixture;

b) blending the admixture during step (a) or upon completion thereof until the oil and carrier are uniformly distributed.

### DETAILED DESCRIPTION OF THE INVENTION

Solid Carrier

The solid carrier may be any solid carrier compatible with fabric treatment compositions. In particular, the solid carrier may be, for example, selected from a clay, a zeolite, a sugar, a starch, an inorganic salt and mixtures thereof.

It has been found that fabric care compositions comprising a clay and an anti-wrinkle agent, such as a functionalised oil, impart unexpected softness benefits to fabrics treated with such compositions. The compositions also impart anti-wrinkle benefits to fabrics treated with the compositions. The softness and anti-wrinkle benefits are typically greater than those obtained from compositions comprising only one of the anti-wrinkle agent or the clay. Thus, the softness obtained from a composition comprising a clay and an anti-wrinkle agent is typically greater than the softness obtained from a composition comprising just the clay as a softening agent. In addition, the combined composition typically also provides a greater anti-wrinkle effect than a composition containing just the anti-wrinkle agent.

The fabric care composition typically comprises the clay in an amount of from 0.001% to 10% by weight of the composition. More preferably the clay is present in an amount of from 0.01% to 5% by weight of the composition. Advantageously, the clay is present in an amount of from 0.1% to 1% by weight of the composition. The clay may be a single clay or a mixture of different clays.

The clay is preferably a clay which has not been subjected to a cation exchange reaction.

The clay typically comprises material classified as smectite-type. Suitable smectite-type clays are preferably impalpable, expandable, three-layer clays such as, for example, aluminosilicates and magnesium silicates having an cation exchange capacity of at least 50 milliequivalents per 100 grams of clay. The smectite-type clay preferably has a cationic exchange capacity of at least 75 milliequivalents per 100 g of clay, as determined by the well-known ammonium acetate method.

The term “impalpable” means that the individual clay particles are preferably of such a size that they cannot be perceived tactilely. Such particle sizes are in general below 100 microns in diameter. Preferably, however, the clays will have a particle size (ie, a maximum dimension) within the range of from 0.01 to 50 microns.

The term “expandable” as used to describe the clays relates to the ability of the layered clay structure to be swollen, or expanded, on contact with water.

Smectite-type clays are well known in the art and are commercially available from a number of sources. In addition, suitable smectite-type clays may be synthesised by a pneumatolytic or hydrothermal process, such as, for example, disclosed in U.S. Pat. No. 3,252,757.

The smectite-type clay is preferably selected from the group consisting of: montmorillonite, bentonite, beidellite, hectorite, saponite, stevensite, and mixtures thereof. Where appropriate, the clays will have been subjected to the application of shear. The smectite-type clays may be sheared by processes well known to those in the art, such as disclosed in U.S. Pat. No. 4,695,402, for example.

More preferably the smectite-type clay is selected from bentonite and hectorite or mixtures thereof.

An additional or alternative solid carrier may be a zeolite. Zeolites are typically aluminosilicates and synthetic zeolites are commercially available under the designations zeolite A, zeolite B, zeolite P, zeolite X, zeolite HS, zeolite MAP and mixtures thereof. Naturally occurring zeolites may also be used as the solid carrier. In certain known detergent compositions, zeolites are included as detergent builders. Thus, zeolites are well known to those skilled in the art and need not be described in more detail herein. However, they may be included within compositions according to the present invention to fulfil a dual role, namely to act as both a carrier for the liquid anti-wrinkle agent and as a detergent builder;

As a sugar or sugar derivative solid carrier, maltodextrin may be used, although other sugar or sugar derived solid materials may be used as the solid carrier, such as a starch. The solid carrier may be a single sugar or sugar derivative, or it may be a mixture of sugars or their derivatives.

A solid inorganic salt may be used as the solid carrier. For reasons of cost and ease of production, it is preferred to use a solid inorganic salt which is typically included within fabric care compositions, such as for example sodium carbonate or sodium bicarbonate. Other solid inorganic salts (excluding clays and zeolites already mentioned above) may be used, provided they are readily compatible with fabric care compositions.

Anti-Wrinkle Agent

The compositions of the invention also comprise an anti-wrinkle agent, preferably a liquid anti-wrinkle agent such as a functionalised oil or a non-functionalised oil, eg. a silicone oil or derivatives thereof. The functionalised oil may be a single functionalised oil or a mixture of different functionalised oils. The term “functionalised” includes the presence of any functional group, structural unit or units capable of being attached by any chemical means to an oil, or otherwise incorporated within an oil, such that the functional group enables the functionalised oil to have increased solubility in an aqueous environment.

Preferably, the anti-wrinkle agent (on a 100% active basis) is present in an amount of from 0.01% to 50% by weight of the composition, more preferably, the amount of anti-wrinkle agent (on a 100% active basis) is from 0.1% to 30% by weight of the composition. In an especially preferred embodiment of the invention, the amount of anti-wrinkle agent (on a 100% active basis) is from 0.1% to 10% by weight of the composition.

Furthermore, in a particularly preferred embodiment of the invention the weight ratio of (i): (ii) (i.e. solid carrier to anti-wrinkle agent) varies from 20:1 to 1:20, more preferably from 10:1 to 1:10, even more preferably from 5:1 to 1:5 and most preferably 2:1 to 1:2.

In the functionalised oil, the functionalised group will preferably comprise one or more polar functional groups. The polar functional group may or may not bear a formal positive or negative charge. If formally charged, however, the functional group will be associated with a counterion chosen so as not to interfere with the functionalised oil. Suitable counterions may, for example, be chosen from the group consisting of: alkali and alkaline earth metals, ammonium and organic ammonium salts, chloride, bromide, hydroxyl, acetate, nitrite, and mixtures thereof.

The functional group or structural unit preferably comprises one or more of the following polar groups:, anionic groups such as, for example, sulfate, sulfonate, phosphate, phosphonate, carboxylate, carbonate, ethoxylate, hydroxyl, nitrate and nitrite; cationic groups such as, for example, —NH₃⁺, or —NR₃⁺, where R is an alkyl group containing 1 to 6 carbon atoms, or mixtures thereof. The functional group may be attached or otherwise included in the oil according to any of the methods well known in the art.

Typically, the functionalised oil comprises a functionalised vegetable oil, in which the vegetable oil is preferably selected from the group consisting of: corn oil, coconut oil, soybean oil, cotton-seed oil, castor oil, linseed oil, sunflower oil, palm oil, peanut oil, lanolin, sesame oil, olive oil, avocado oil, truffle oil, rapeseed oil, soyabean oil, maize oil and mixtures thereof.

Preferably, the functionalised oil is a sulfated vegetable oil; more preferably, the functionalised oil is sulfated castor oil.

Methods of synthesising sulfated castor oil from natural materials are well known to those skilled in the art. Suitable sulfated castor oil may also be obtained commercially from Goodrich under the trade marks Freedom SCO-50 or Freedom SCO-75.

Alternatively or additionally, the anti-wrinkle composition may also comprise a functionalized oil or fat of synthetic or animal origin. Examples of such oils include silicone oils, mineral oils and tallows. If this invention includes a functionalized oil of synthetic origin, preferably this oil is a silicone oil. More preferably, it is either a silicone poly ether or amino-functional silicone. If the composition incorporates a silicone poly ether, it is preferably of one of the two general structures shown below:

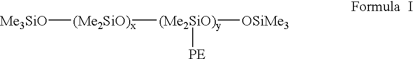

Formula II

(MeSi)_{y-2}—[(OSiMe₂)_{x/y}OPE]_{y}

Where PE Represents:

CH₂—CH₂—CH₂—O—(EO)ₘ—(PO)ₙ—Z

and Me represents methyl, EO represents ethylene oxide, PO represents 1,2 propylene oxide, Z represents either a hydrogen or a lower alkyl radical, x,y,m and n are constants and can be varied to alter the properties of the functionalized silicone.

A molecule of either structure can be used for the purposes of this invention. Preferably, this molecule contains more than 30% silicone, more than 20% ethylene oxide and less than 30% propylene oxide by weight, and has a molecular weight of more than 5,000. An example of a suitable, commercially available such material is L-7622, available from Crompton Corporation, Greenwich, Conn.

Amino-functional silicones come in a wide variety of structures, which are well-known to those skilled in the art. These are also useful in the context of this invention, although over time many of these materials can oxidize on fabrics, leading to yellowing. As this is not a desirable property of a fabric care composition, if an amino-functional silicone is used, preferably it is a hindered amine light stabilised product, which exhibits a greatly reduced tendency to show this behaviour. A commercially available example of such a silicone is Hydrosoft, available from Rhodia—US of Cranbury, N.J.

In place of the functionalised oil, or in addition to it, the anti-wrinkle agent may comprise a non-functionalised oil, such as a silicone oil or a mineral oil. Examples of the such oils that may be used as anti-wrinkle agents in this invention include paraffin oils and polydimethylsiloxanes. Polydimethylsiloxanes can be synthesized in many different molecular weights, using methods well known to those skilled in the art. If this invention includes a polydimethylsiloxane, preferably the viscosity of this material is between 100 and 100,000 cPs. Such products can be obtained under the trademark of L-45 from Crompton Corporation, Greenwich, Conn.

Without wishing to be bound by theory, it is believed that the carrier acts as a deposition aid for the anti-wrinkle agent, which results in an improved anti-wrinkle benefit imparted by the agent. In addition, where the solid carrier is a clay which is able to impart a softening effect, it is believed the anti-wrinkle agent may act as a dispersing agent for the clay, which results in an improved softening benefit imparted by the clay.

As well as acting as a dispersing agent, the anti-wrinkle agent may also help to suspend the solid carrier. Thus, compositions containing both a carrier component and an anti-wrinkle agent are less susceptible to the solid carrier sedimenting out of suspension and, for example, sinking to the bottom of the container upon standing. Accordingly, the anti-wrinkle agent preferably also functions as a suspending agent in fabric care compositions. This is particularly useful in compositions where the solid carrier has a secondary function in addition to acting as a carrier, such as, for example, where the solid carrier is a clay (softening agent), a zeolite (detergent builder) or a carbonate or bicarbonate salt (detergent builder).

Formulations

The compositions of the present invention may be formulated as a powder or granules, which may be combined with additional fabric care components to form a fabric care composition in the form of a powder or a tablet or a liquid.

If granular, it is preferred that the composition is free-flowing.

Alternatively, where the end composition is to be a liquid, the individual components of the invention may be added in an aqueous carrier such as water.

Thus, the compositions of the invention preferably also comprise one or more textile compatible wash components. The nature of the wash components will be dictated to a large extent by the stage at which the composition of the invention is to be used in the laundering process, the compositions being capable of being used, in principle, at any stage of the process. For example, where the compositions are for use as main wash detergent compositions, the one or more wash components include a detergent active compound. Where the compositions are for use in the rinsing step of a laundering process, the one or more wash components may include a fabric softening and/or conditioning compound.

The compositions of the invention preferably comprise a perfume, such as of the type which is conventionally used in fabric care compositions. The compositions may be packaged and labelled for use in a domestic laundering process.

In the context of the present invention the wash component is preferably a component which can assist in the interaction of the carrier and/or the anti-wrinkle agent with the fabric. The wash component can also provide benefits in addition to those provided by the carrier and/or the anti-wrinkle agent e.g. softening, cleaning etc.

The wash component may be an aqueous liquid, in which case the carrier and the anti-wrinkle agent are each dispersed or dissolved in the liquid as appropriate. Alternatively, the wash component may be a solid component e.g. granular. In this case, the anti-wrinkle agent may first be adsorbed onto the carrier and the agent/carrier component then simply admixed with the wash component. One way to achieve this may be to spray dry a slurry comprising water, the anti-wrinkle agent and the carrier. In an alternative embodiment, the wash component, the carrier and the anti-wrinkle agent are formed together into a solid granular product, in accordance with conventional techniques.

If the composition of the invention is to be used before, or after, the laundry process, however, it may be in the form of a spray or foaming product.

The fabrics which may be treated with compositions according to the present invention include those which comprise cellulosic fibres, preferably from 1% to 100% cellulosic fibres (more preferably 5% to 100% cellulosic fibres, most preferably 40% to 100%). The fabric may be in the form of a garment, in which case the method of the invention may represent a method of laundering a garment. When the fabric contains less than 100% cellulosic fibres, the balance comprises other fibres or blends of fibres suitable for use in garments such as polyester, for example. Preferably, the cellulosic fibres are of cotton or regenerated cellulose such as viscose.

The laundering processes of the present invention include the large scale and small scale (eg domestic) cleaning of fabrics. Preferably, the processes are domestic.

In the invention, the composition of the invention may be used at any stage of the laundering process. Preferably, the composition is used to treat the fabric in the rinse cycle of a laundering process. The rinse cycle preferably follows the treatment of the fabric with a detergent composition.

The compositions of the invention may therefore comprise water, preferably in an amount of from 0.01% to 90% by weight, more preferably from 1% to 75% by weight.

Detergent Active Compounds

If the composition of the present invention is in the form of a detergent composition, the wash component may include a detergent chosen from soap and non-soap anionic, cationic, nonionic, amphoteric and zwitterionic detergent active compounds, and mixtures thereof.

Many suitable detergent active compounds are available and are fully described in the literature, for example, in “Surface-Active Agents and Detergents”, Volumes I and II, by Schwartz, Perry and Berch.

The preferred detergent wash components that can be used are soaps and synthetic non-soap anionic and nonionic compounds. Anionic surfactants are well-known to those skilled in the art. Examples include alkylbenzene sulchonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

Cationic surfactants that may be used include quaternary ammonium salts of the general formula R₁R₂R₃R₄N⁺ X⁻ wherein the R groups are independently hydrocarbyl chains of C₁-C₂₂ length, typically alkyl, hydroxyalkyl or ethoxylated alkyl groups, and X is a solubilising cation (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters) and pyridinium salts.

The total quantity of detergent surfactant in the composition is suitably from 0.1 to 60 wt % e.g. 0.5-55 wt %, such as 5-50 wt %.

Preferably, the quantity of anionic surfactant (when present) is in the range of from 1 to 50% by weight of the total composition. More preferably, the quantity of anionic surfactant is in the range of from 3 to 35% by weight, e.g. 5 to 30% by weight.

Preferably, the quantity of nonionic surfactant when present is in the range of from 2 to 25% by weight, more preferably from 5 to 20% by weight.

Amphoteric surfactants may also be used, for example amine oxides or betaines.

The compositions may suitably contain from 10 to 70%, preferably from 15 to 70% by weight, of detergency builder. Preferably, the quantity of builder is in the range of from 15 to 50% by weight.

The detergent composition may contain as builder a crystalline aluminosilicate, preferably an alkali metal aluminosilicate, more preferably a sodium aluminosilicate.

The aluminosilicate may generally be incorporated in amounts of from 10 to 70% by weight (anhydrous basis), preferably from 25 to 50%. Aluminosilicates are materials having the general formula:

0.8-1.5 M₂O. Al₂O₃. 0.8-6 SiO₂

where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature.

A preferred process of preparing a free-flowable antiwrinkle agent suitable for inclusion in a powder or tablet detergent product, comprises the steps of:

a) combining a functionalised oil with a solid carrier selected from clays, zeolites, sugar or derivatives thereof, solid salts, starch or derivatives thereof, and mixtures thereof to form an admixture; and

b) blending the admixture during step (a) or upon completion thereof until the oil and carrier are uniformly distributed.

Fabric Softening and/or Conditioner Compounds

If the composition of the present invention is in the form of a fabric conditioner composition, the wash component will preferably include a fabric softening and/or conditioning compound (hereinafter referred to as “fabric softening compound”), which may be a cationic or nonionic compound.

The fabric softening compounds may be water insoluble quaternary ammonium compounds. The compounds may be present in amounts of up to 8% by weight (based on the total amount of the composition) in which case the compositions are considered dilute, or at levels from 8% to about 50% by weight, in which case the compositions are considered concentrates.

Compositions suitable for delivery during the rinse cycle may also be delivered to the fabric in the tumble dryer if used in a suitable form. Thus, another product form is a composition (for example, a paste) suitable for coating onto, and delivery from, a substrate e.g. a flexible sheet or sponge or a suitable dispenser during a tumble dryer cycle.

Suitable cationic fabric softening compounds are substantially water-insoluble quaternary ammonium materials comprising a single alkyl or alkenyl long chain having an average chain length greater than or equal to C₂₀ or, more preferably, compounds comprising a polar head group and two alkyl or alkenyl chains having an average chain length greater than or equal to C₁₄. Preferably the fabric softening compounds have two long chain alkyl or alkenyl chains each having an average chain length greater than or equal to C₁₆. Most preferably at least 50% of the long chain alkyl or alkenyl groups have a chain length of C₁₈ or above. It is preferred if the long chain alkyl or alkenyl groups of the fabric softening compound are predominantly linear.

Quaternary ammonium compounds having two long-chain aliphatic groups, for example, distearyldimethyl ammonium chloride and di(hardened tallow alkyl) dimethyl ammonium chloride, are widely used in commercially available rinse conditioner compositions. Other examples of these cationic compounds are to be found in “Surface-Active Agents and Detergents”, Volumes I and II, by Schwartz, Perry and Berch. Any of the conventional types of such compounds may be used in the compositions of the present invention.

The fabric softening compounds are preferably compounds that provide excellent softening, and are characterised by

a chain melting Lβ to Lα transition temperature greater than 25° C., preferably greater than 35° C., most preferably greater than 45° C. This Lβ to Lα transition can be measured by DSC as defined in “Handbook of Lipid Bilayers”, D Marsh, CRC Press, Boca Raton, Fla., 1990 (pages 137 and 337).

Substantially water-insoluble fabric softening compounds are defined as fabric softening compounds having a solubility of less than 1×10⁻³ wt % in demineralised water at 20° C. Preferably the fabric softening compounds have a solubility of less than 1×10⁻⁴ wt %, more preferably less than 1×10⁻⁸ to 1×10⁻⁶ wt %.

Especially preferred are cationic fabric softening compounds that are water-insoluble quaternary ammonium materials having two C₁₂₋₂₂ alkyl or alkenyl groups connected to the molecule via at least one ester link, preferably two ester links.

A first group of preferred ester-linked cationic surfactant materials for use in the invention is represented by formula

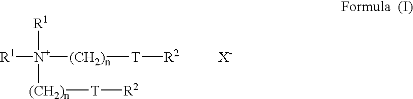

wherein each R¹ group is independently selected from C₁₋₄ alkyl or C₂₋₄ alkenyl groups; and wherein each R² group is independently selected from C₈₋₂₈ alkyl or alkenyl groups;

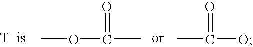

X⁻ is any anion compatible with the cationic surfactant, such as halides or alkyl sulphates, e.g. chloride, methyl sulphate or ethyl sulphate and n is 0 or an integer from 1-5.

A second preferred softening material for use in the invention is represented by formula (II):

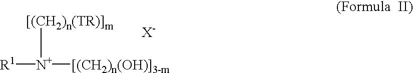

wherein each R is independently selected from a C₅₋₃₅ alkyl or alkenyl group, R¹ represents a C₁₋₄ alkyl or hydroxyalkyl group or a C₂₋₄ alkenyl group, m is 1, 2 or 3 and denotes the number of moieties to which it refers that pend directly from the N atom and T, n and X⁻ are as defined above.

Especially preferred materials within this formula are di-alkenyl esters of triethanol ammonium methyl sulphate. Commercial examples of compounds within this formula are Tetranyl® AOT-1 (di-oleic ester of triethanol ammonium methyl sulphate 80% active), AO-1 (di-oleic ester of triethanol ammonium methyl sulphate 90% active), Tetranyl® AHT-1 (di-hardened tallowyl ester of triethanol ammonium methyl sulphate 85% active), L1/90 (partially hardened tallow ester of triethanol ammonium methyl sulphate 90% active), L5/90 (palm ester of triethanol ammonium methyl sulphate 90% active (supplied by Kao corporation); Rewoquat WE15 (C₁₀-C₂₀ and C₁₆-C₁₈ unsaturated fatty acid reaction products with triethanolamine dimethyl sulphate quaternised 90% active), WE18 and WE20 (both are partially hardened tallow ester of triethanol ammonium methyl sulphate 90% active), ex Goldschmidt Corporation; and Stepantex VK-90 (partially hardened tallow ester of triethanol ammonium methyl sulphate 90% active), ex Stepan Company.

A third preferred type of quaternary ammonium material is represented by formula (III):

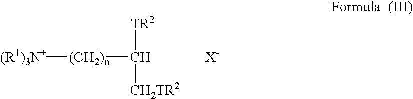

wherein R¹, R², n, T and X⁻ are as defined above.

Preferred materials of this class such as 1,2 bis[tallowoyloxy]-3-trimethylammonium propane chloride and 1,2-bis[oleyloxy]-3-trimethylammonium propane chloride and their method of preparation are, for example, described in U.S. Pat. No. 4,137,180 (Lever Brothers), the contents of which are incorporated herein. Preferably these materials also comprise small amounts of the corresponding monoester, as described in U.S. Pat. No. 4,137,180.

A fourth preferred type of quaternary ammonium material is represented by formula (IV):

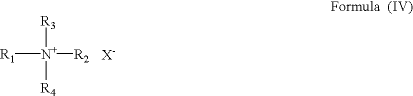

where R₁ and R₂ are C₈₋₂₈ alkyl or alkenyl groups; R₃ and R₄ are C₁₋₄ alkyl or C₂₋₄ alkenyl groups and X⁻ is as defined above.

Examples of compounds within this formula include di(tallow alkyl)dimethyl ammonium chloride, di(tallow alkyl) dimethyl ammonium methyl sulphate, dihexadecyl dimethyl ammonium chloride, di(hardened tallow alkyl) dimethyl ammonium chloride, dioctadecyl dimethyl ammonium chloride and di(coconut alkyl) dimethyl ammonium chloride.

Other useful cationic softening agents are alkyl pyridinium salts and substituted imidazoline species. Also useful are primary, secondary and tertiary amines and the condensation products of fatty acids with alkylpolyamines.

The compositions may alternatively or additionally contain water-soluble cationic fabric softeners, as described in GB 2 039 556B (Unilever).

The compositions may comprise a cationic fabric softening compound and an oil, for example as disclosed in EP-A-0829531.

The compositions may alternatively or additionally contain the polyol polyester (eg, sucrose polyester) compounds described in WO 98/16538.

The compositions may alternatively or additionally contain nonionic fabric softening agents such as lanolin and derivatives thereof.

Lecithins are also suitable softening compounds.

Nonionic softeners include Lβ phase forming sugar esters (as described in M Hato et al Langmuir 12, 1659, 1666, (1996)) and related materials such as glycerol monostearate or sorbitan esters. Often these materials are used in conjunction with cationic materials to assist deposition (see, for example, GB 2 202 244). Silicones are used in a similar way as a co-softener with a cationic softener in rinse treatments (see, for example, GB 1 549 180).

The compositions may also suitably contain a nonionic stabilising agent. Suitable nonionic stabilising agents are linear C₈ to C₂₂ alcohols alkoxylated with 10 to 20 moles of alkylene oxide, C₁₀ to C₂₀ alcohols, or mixtures thereof.

Advantageously the nonionic stabilising agent is a linear C₈ to C₂₂ alcohol alkoxylated with 10 to 20 moles of alkylene oxide. Preferably, the level of nonionic stabiliser is within the range from 0.1 to 10% by weight, more preferably from 0.5 to 5% by weight, most preferably from 1 to 4% by weight. The mole ratio of the quaternary ammonium compound and/or other cationic softening agent to the nonionic stabilising agent is suitably within the range from 40:1 to about 1:1, preferably within the range from 18:1 to about 3:1.

The composition can also contain fatty acids, for example C₈ to C₂₄ alkyl or alkenyl monocarboxylic acids or polymers thereof. Preferably saturated fatty acids are used, in particular, hardened tallow C₁₆ to C₁₈ fatty acids. Preferably the fatty acid is non-saponified, more preferably the fatty acid is free, for example oleic acid, lauric acid or tallow fatty acid. The level of fatty acid material is preferably more than 0.1% by weight, more preferably more than 0.2% by weight. Concentrated compositions may comprise from 0.5 to 20% by weight of fatty acid, more preferably 1% to 10% by weight. The weight ratio of quaternary ammonium material or other cationic softening agent to fatty acid material is preferably from 10:1 to 1:10.

The fabric conditioning compositions may include soil release polymers such as block copolymers of polyethylene oxide and terephthalate; amphoteric surfactants;

zwitterionic quaternary ammonium compounds; and nonionic surfactants.

The fabric conditioning compositions may be in the form of emulsions or emulsion precursors thereof.

Other optional ingredients include emulsifiers, electrolytes (for example, sodium chloride or calcium chloride) preferably in the range from 0.01 to 5% by weight, pH buffering agents, and perfumes (preferably from 0.1 to 5% by weight).

Further Optional Ingredients

Further optional ingredients in the compositions of the invention include non-aqueous solvents, perfume carriers, fluorescers, colourants, hydrotropes, antifoaming agents, antiredeposition agents, enzymes, optical brightening agents, opacifiers, dye transfer inhibitors, anti-shrinking agents, anti-spotting agents, germicides, fungicides, anti-oxidants, UV absorbers (sunscreens), heavy metal sequestrants, chlorine scavengers, dye fixatives, anti-corrosion agents, drape imparting agents, antistatic agents, ironing aids, bleach systems and soil release agents. This list is not intended to be exhaustive.

The compositions of the invention may also include an agent which produces a pearlescent appearance, e.g. an organic pearlising compound such as ethylene glycol distearate, or inorganic pearlising pigments such as microfine mica or titanium dioxide (TiO₂) coated mica.

An anti-settling agent may be included in the compositions of the invention. The anti-settling agent, which reduces the tendency of solid particles to separate out from the remainder of a liquid composition, is preferably used in an amount of from 0.5 to 5% by weight of the composition. Organophilic quaternised ammonium-clay compounds and fumed silicas are examples of suitable anti-settling agents.

A further optional ingredient in the compositions of the invention is a flocculating agent which may act as a delivery aid to enhance deposition of the active ingredients (such as the water insoluble particles) onto fabric. Flocculating agents may be present in the compositions of the invention in amounts of up to 10% by weight, based on the weight of the clay. Suitable flocculating agents include polymers, for example long chain polymers and copolymers comprising repeating units derived from monomers such as ethylene oxide, acrylamide, acrylic acid, dimethylaminoethyl methacrylate, vinyl alcohol, vinyl pyrrolidone, ethylene imine and mixtures thereof. Gums such as guar gum, optionally modified, are also suitable for use as flocculating agents.

Other possible delivery aids for the water insoluble particles include, for example, the water-soluble or water-dispersible rebuild agents (e.g. cellulose monoacetate) described in WO 00/18860.

A preferred composition comprises a clay and a functionalised oil, preferably a sulfated castor oil.

The invention will now be described by way of example only and with reference to the following non-limiting examples. In the examples and throughout this specification all percentages are percentages by weight unless indicated otherwise.

### EXAMPLE 1

The following table details a series of wrinkle-reduction agent granule formulations which have recently been generated. These were accomplished via two different procedures, as noted in the table, each of which is described below.

Procedure 1:

In a Waring (Torrington, Conn.) 7011 laboratory blender equipped with a Waring SS115 dry-blending container, 150 g of powdered carrier were fluidized and rapidly mixed at “high” (22,000 rpm no-load) speed. After one minute, the wrinkle-reduction agent was dosed to the system over the course of 5 minutes via a syringe. The mixture was then permitted to blend for another minute, after which it yielded (unless otherwise noted) off-white, free-flowing granules which were readily mixable with a commercial spray-dried or granular detergent composition.

Procedure 2:

200 g of zeolite A24 were charged to a Kitchenaid (St Joseph, MI) KSB5SS commercial blender and fluidized at the “puree” speed. Following this, the wrinkle-reduction agent, which was heated to 42° C. before the process began, was fed through a 0.5 cm opening at the top of the blender via gravity over 10 minutes. This mixture was then allowed to agitate for another 5 minutes, after which it was discharged. In each case the product of this procedure was a free-flowing powder suitable for incorporation into a commercial detergent formulation.

| | | | | Loading |
|---|---|---|---|---|
| | | | | (% agent, |
| Sample | Procedure | Wrinkle Reduction | | active |
| # | # | Agent | Carrier | basis) |
| 1 | 1 | Sulfated Castor Oil¹ | Zeolite A24² | 17.18% |
| 2 | 2 | Polydimethylsiloxane³ | Zeolite A24 | 8.46% |
| 3 | 2 | Polydimethylsiloxane | Zeolite A24 | 23.18% |
| 4 | 1 | Polydimethylsiloxane | Maltodextrin⁴ | 25.82% |
| 5 | 1 | Polydimethylsiloxane | Light Soda | 18.83% |
| | | | Ash⁵ | |
| 6 | 1 | HALS Silicone⁶ | Zeolite A24 | 7.82% |
| 7 | 1 | Silwet L-7622⁷ | Zeolite A24 | 31.31% |
| 8 | 1 | Silwet L-7622 | Bentonite | 35.36% |
| | | | Clay⁸ | |
| 9 | 1 | Sulfated Caster Oil | Vebtibute | 34.6% |
| | | | Clay | |

¹Freedom SCO-50, available from B F Goodrich Chemical, Charlotte, NC.
²Zeolite A24, available from Crosfield Company, Joliet, IL.
³L-45 (10,000 cst), available from Crompton Corporation, Greenwich, CT.
⁴Available from Sigma-Aldrich, Milwaukee, WI.
⁵Light Soda Ash, available from Solvay America, Houston, TX.
⁶Hydrosoft emulsion, available from Rhodia US, Cranbury, N.J.
⁷Silwet L-7622, available from Crompton Corporation, Greenwich, CT.
⁸Gelwhite GP, available from Southern Clay Products, Gonzales, TX.

### EXAMPLE 2

A composition within the boundaries of the following general formula was prepared and gently blended.

| | Range |
|---|---|
| Ingredient | (%) |
| Wrinkle-Reducing Granules from Example 1 | 10-40 |
| Sodium Linear Alkylbenzene Sulfonate | 5-15 |
| Alcohol Ethoxylate | 2-8 |
| Sodium Soap | 0-2 |
| Zeolite A24 | 10-40 |
| Sodium Carbonate | 5-15 |
| Sodium Acetate Trihydrate | 2-40 |
| Antiredeposition Agent⁹ | 0-4 |
| Proteolytic Enzyme | 0-3 |
| Lipolytic Enzyme | 0-3 |
| Amylitic Enzyme | 0-3 |
| Mannanase | 0-3 |
| Cellulase | 0-3 |
| Sodium Silicate | 0-12 |
| Sodium Sulfate | 0-20 |
| Fluorescent Whitening Agent | 0-2 |
| Perfume, colorants | 0-5 |

⁹Examples of Antiredeposition agents include, but are not limited to acrylate soil-release polymers, sodium carboxymethylcellulose and tetraethylpentamine.

These ingredients were then charged to a round pelleting die with a diameter of 4.4 cm. This article was placed in a Specac 530-227 (Smyrna, Ga.) pneumatic press and compressed at 1.1 bar for approximately 5 seconds, resulting in a solid detergent tablet with a height of 2.0 cm. This tablet and others produced via this procedure were then analyzed and determined to have acceptable durability and dissolution characteristics.

### EXAMPLE 3

A further example composition was prepared as follows:

| Ingredient | Amount (wt %) |
|---|---|
| Sodium linear alkylbenzene sulphonate | 7.05 |
| Alcohol ethoxylate (7EO) nonionic surfactant | 3.09 |
| Sodium soap | 0.55 |
| Zeolite A24 | 15.75 |
| Sodium acetate trihydrate | 8.58 |
| Light soda ash | 2.34 |
| SCMC | 0.31 |
| Moisture, salts, NDOM | 2.82 |
| EAG (NTR Casale-17% sil. Oil) | 1.73 |
| Fluorescer adj. | 1.20 |
| STP (HPA) | 29.82 |
| Gerol | 0.14 |
| Sodium disilicate (granules) | 2.06 |
| TAED white (83% as granules) | 2.34 |
| Coated percarbonate (13.5 AvOx) | 9.91 |
| Dequest 2047 | 1.03 |
| Savinase (12.0 T 3250 GU/mg) | 0.32 |
| Lipolase (100 T 187 LU/mg) | 0.08 |
| Clay (QPC 200) | 6.41 |
| Sulphated castor oil (SCO-75) | 4.37 |
| Rubacara | 0.09 |
| Dye (pigment blue 29) | 0.01 |

1. A fabric care composition comprising
(i) a solid carrier; and
(ii) an anti-wrinkle agent.

2. A fabric care composition according to claim 1, wherein the solid carrier is selected from clays, zeolites, sugar or derivatives thereof, solid salts, starch or derivatives thereof, and mixtures thereof.

3. A fabric care composition according to claim 2 wherein the clay has not been subjected to a cation exchange reaction.

4. A fabric care composition according to claim 2 wherein the clay comprises a smectite-type clay.

5. A fabric care composition according to claim 4 wherein the smectite-type clay is selected from the group consisting of: montmorillonite, bentonite, beidellite, hectorite, saponite, stevensite, and mixtures thereof.

6. A fabric care composition according to claim 2, wherein the clay is in particulate form.

7. A fabric care composition according to claim 1 wherein the anti-wrinkle agent comprises a functionalised vegetable oil in which the vegetable oil is selected from the group consisting of corn oil, coconut oil, soybean oil, cotton-seed oil, castor oil, linseed oil, sunflower oil, palm oil, peanut oil, lanolin, sesame oil, olive oil, avocado oil, truffle oil, rapeseed oil, soyabean oil, maize oil and functionalised mixtures thereof.

8. A fabric care composition according to claim 7, wherein the functionalised vegetable oil is a sulfated vegetable oil.

9. A fabric care composition according to claim 8 wherein the functionalised vegetable oil is sulfated castor oil.

10. A fabric care composition according to claim 1, wherein the anti-wrinkle agent is a silicone oil.

11. A fabric care composition according to claim 1, wherein the carrier is present in an amount of from about 1% to about 90% by weight of the composition.

12. A fabric care composition according to claim 1 wherein the anti-wrinkle agent is present in an amount of from 0.01% to 50% by weight of the composition.

13. A fabric care composition according to claim 1 wherein the weight ratio of (i):(ii) is in the range of from 20:1 to 1:20.

14. A fabric care composition according to claim 1, wherein the composition further includes a wash component.

15. A fabric care composition according to claim 14, wherein the wash component is a liquid.

16. A fabric care composition according to claim 14, wherein the wash component is a solid.

17. Use of a composition as defined in claim 1 to provide softness benefits for fabric.

18. Use of a composition as defined in claim 1 16 to provide anti-wrinkle benefits for fabric.

19. A method of treating a fabric, the method comprising applying-to the fabric a compositions according to claim 1.

20. A fabric care composition according to claim 1 which is free flowable.

21. A process of preparing a free-flowable antiwrinkle agent suitable for inclusion in a powder or tablet detergent product, comprising the steps of:
c) combining a functionalised oil with a solid carrier selected from clays, zeolites, sugar or derivatives thereof, solid salts, starch or derivatives thereof, and mixtures thereof to form an admixture;
d) blending the admixture during step (a) or upon completion thereof until the oil and carrier are uniformly distributed.

22. A fabric care composition comprising:
a) a granular fabric care composition according to claim 1; and
b) a spray-dried, dry-blended or granulated detergent composition.
